(19) United States
(12) Patent Application Publication
(10) Pub. No.: US 2025/0138897 A1
(43) Pub. Date: May 1, 2025

(54) DATA PROCESSING SYSTEMS

(71) Applicant: Arm Limited, Cambridge (GB)

(72) Inventors: Eric Kunze, Santa Clara, CA (US); John Wakefield Brothers, III, Calistoga, CA (US); Elliot Maurice Simon Rosemarine, London (GB)

(73) Assignee: Arm Limited, Cambridge (GB)

(21) Appl. No.: 18/499,014

(22) Filed: Oct. 31, 2023

(51) Int. Cl. G06F 9/50

(52) U.S. Cl. CPC G06F 9/5038; G06F 9/5016; G06F 9/5044

(57) ABSTRACT

In a data processing system, a command stream provided to a processing resource to cause the processing resource to perform a processing task for an application executing on a host processor comprises a sequence of commands for execution by the processing resource to cause the processing resource to perform the processing operations for the processing task and one or more data save indicators that indicate data that is to be saved. In response to the processing resource receiving a request to suspend processing of the processing task, data indicated by one of the one or more data save indicators in the command stream is stored in memory.

### BACKGROUND

The technology described herein relates to the operation of data processing systems and, in particular, to the suspending (and resuming) of processing tasks in data processing systems.

Many data processing systems include processing resources, such as a graphics processor (graphics processing unit (GPU), that may perform processing operations for, e.g., applications that are executing on a, e.g. main (e.g. host), processor (CPU) of the data processing system.

The processing resource may be caused to perform processing operations for an application by providing to the processing resource a stream of commands (instructions) to be executed by the processing resource. For example, a driver for the processing resource may prepare a command stream containing commands (instructions) to be performed by the processing resource, and provide the command stream to the processing resource, with the processing resource then executing the commands (the operations indicated by the commands) in the command stream.

A command stream may, for example, contain commands (instructions) to set parameters for processing tasks, as well as commands to execute the processing operations required for processing tasks. The processing resource will work through the command stream, executing the commands (instructions) in the command stream, e.g. in turn.

In certain circumstances, it may be required to suspend processing of a current processing task by a processing resource. When it is required to suspend processing of a current processing task, it may be desirable to save in memory data which has been created or changed during execution of the current processing task before suspending the processing of that processing task, e.g. in order to be able to resume processing of that processing task at a later time. In this way, created or changed data is not lost when a processing task is suspended (e.g. processing operations which have already been performed may not need to be repeated in the event of the processing task being resumed).

The Applicants believe that there remains scope for improvements in operating data processing systems in which processing tasks being performed by a processing resource may be suspended and then may need to be resumed.

### BRIEF DESCRIPTION OF THE DRAWINGS

A number of embodiments of the technology described herein will now be described by way of example only and with reference to the accompanying drawings, in which:

FIG. 1 schematically shows a data processing system that can be operated according to the technology described herein;

FIG. 2 schematically shows another data processing system that can be operated according to the technology described herein;

FIG. 3 shows a method of operating a data processing system in an embodiment of the technology described herein;

FIG. 4 shows a method of generating a command stream in an embodiment of the technology described herein;

FIG. 5A shows a memory table in an embodiment of the technology described herein;

FIG. 5B shows a plurality of data save indicators and a data retrieval indicator in an embodiment of the technology described herein;

FIG. 6 schematically shows a command stream in an embodiment of the technology described herein;

FIG. 7 shows a method for determining “permitted suspend” point locations in an embodiment of the technology described herein; and

FIG. 8 shows a method of operating a data processing system in an embodiment of the technology described herein.

### DETAILED DESCRIPTION

A first embodiment of the technology described herein comprises a method of operating a data processing system that comprises:
a host processor;
a main memory resource associated with the host processor;
a processing resource operable to perform data processing operations for applications executing on the host processor; and
a working memory resource associated with the processing resource;
the method comprising:
   providing, by the host processor, in response to a request for processing to be performed by the processing resource from an application executing on the host processor, a command stream to the processing resource to cause the processing resource to perform a processing task comprising one or more processing operations, the command stream comprising:
      a sequence of commands for execution by the processing resource to cause the processing resource to perform the processing operations for the processing task; and
      one or more data save indicators that indicate data that is to be saved;
         and
executing, by the processing resource, the commands in the command stream to perform the processing operations for the processing task;
the method further comprising:
   in response to the processing resource receiving a request to suspend processing of the processing task being performed:
      storing in the main memory resource data indicated by one of the one or more data save indicators in the command stream.

A second embodiment of the technology described herein comprises a data processing system comprising:
a host processor;
a main memory resource associated with the host processor;
a processing resource operable to perform data processing operations for applications executing on the host processor; and
a working memory resource associated with the processing resource;
the host processor comprising:
   a circuit configured to provide, in response to a request for processing to be performed by the processing resource from an application executing on the host processor, a command stream to the processing resource to cause the processing resource to perform a processing task comprising one or more processing operations, the command stream comprising:
      a sequence of commands for execution by the processing resource to cause the processing resource to perform the processing operations for the processing task; and
      one or more data save indicators that indicate data that is to be saved;
the processing resource comprising:
   a circuit configured to execute commands in a command stream received by the processing resource to perform processing operations for a processing task; and
   a circuit configured to:
      in response to the processing resource receiving a request to suspend processing of a processing task being performed:
         store in the main memory resource data indicated by a data save indicator in a command stream being executed.

The technology described herein generally relates to suspending processing tasks in data processing systems. Suspending a current processing task may be desirable, for example, in order to perform a different processing task. For instance, in the case of a data processing system providing output to a display, it may be desirable to suspend the display of a first image or sequence of images and to instead display a different image or sequence of images (e.g. to display a warning to a user). It will of course be appreciated that this is only an example and that the technology described herein may be useful in other applications.

When suspending a current processing task, it may be desirable to save the progress of that processing task. In other words, it may be desirable to save data which has been changed or created during the processing of the current processing task up to the point at which processing of the processing task is suspended. In this way, unnecessary repetition of previously completed processing operations of the processing task may be avoided if the processing task is resumed at a later time.

As discussed in more detail below, the technology described herein uses data save indicators included in a command stream that causes a processor to execute a processing task to indicate data that should be saved in the event of the processing task being suspended. The data save indicators can be and are in an embodiment used to indicate data which will have been changed or created up to a given point in the command stream execution. This then avoids the need to actively track changed or created data, for example using markers or “dirty bits”, during processing of a processing task, and so provides a more efficient process for suspending processing tasks in a data processing system.

The Applicants have realised in this regard that for certain processing tasks at least, the operations are predictable, and so it is possible to know in advance what data will be created or changed at what points during execution of a command stream that causes a sequence of the processing operations to be performed.

The technology described herein exploits this by identifying in advance data which should be saved in the event of processing of a command stream being suspended, and including data save indicators accordingly.

The technology described herein can be used in any suitable and desired data processing system comprising a host processor, a main memory resource associated with the host processor, a processing resource operable to perform data processing operations for processing tasks for applications executing on the host processor; and a working memory resource associated with the processing resource.

The host processor is in an embodiment a central processing unit (CPU) that executes an operating system capable of running various applications. The host processor is configured to provide to the processing resource command streams configured to cause the processing resource to perform processing tasks comprising one or more processing operations.

The host processor has an associated main memory resource. The main memory resource may be any suitable and desired memory resource. The main memory resource is configured to store data relating to applications run by the operating system executing on the host processor. In an embodiment, the main memory resource is configured to store command streams which may be provided by the host processor to the processing resource.

The processing resource may be any suitable and desired processing resource (e.g. that can be used to accelerate processing tasks for applications executing on the host processor. Thus, the processing resource may be, and is in an embodiment, one of: a graphics processor (graphics processing unit (GPU)); a video processor (video processing unit (VPU)); an image signal processor (ISP); a digital signal processor (DSP); or a neural processor (neural processing unit (NPU)). Other processing resources would, of course, be possible.

Correspondingly, the processing task that is to be performed by the processing resource can be any suitable and desired processing task that may be required for an application executing on the host processor (and that can be carried out by the processing resource). This may, and in an embodiment does, depend on the nature of the processing resource. In an embodiment, the processing task is an image processing task. In another embodiment, the processing task is an image compression task. In a further embodiment, the processing task is an image decompression task.

The Applicants have recognised that the technology described herein may be of particular use when performing processing and processing tasks where it is possible to know in advance (predict) (e.g. when generating the command stream) what data will be changed or created and when during execution of the processing task. In this case, data which should be saved in the event of a processing task being suspended at a given point can accordingly be identified before processing of that processing task has begun (and, in an embodiment, when generating the command stream for that processing task).

Thus, in an embodiment, the processing task is a processing task for which it is possible to know in advance (predict) (when generating the command stream) what data will be changed or created and when during execution of the command stream for the processing task.

One example of such processing tasks is when performing neural network processing as, in the case of neural network processing, it is generally possible to know in advance what data will be changed or created and when during execution of the neural network processing. Thus, in an embodiment, the processing task is a task that performs neural network processing (a neural network processing task).

In this case, the neural network processing task may be performed by any form of processing resource that is capable of performing the neural network processing task and so it need not necessarily be a neural processing unit (NPU), but could be another form of processing resource, such as a graphics processor, that is being used to perform neural network processing. This said, in an embodiment, the processing resource is correspondingly a processing resource specifically configured to perform neural network processing (a neural processing unit (NPU)).

The technology described herein relates to the situation where the processing of a processing task is suspended in response to a request to suspend processing of that processing task.

The request to suspend processing of the processing task can take any suitable and desired form. The request can be and is in an embodiment any request that explicitly or implicitly indicates or should be taken as indicating, a need to suspend processing of a processing task. It is in an embodiment in the normal form for such requests in the data processing system in question, and may be triggered for any suitable and desired reason, such as, and in an embodiment, the existing reasons as to why processing tasks may be suspended in the data processing system in question.

In one embodiment, the request to suspend processing of the processing task is in the form of a request to switch to processing a different processing task. This may be the case, for example, when a graphics processor is required to switch from processing one output to processing a different output (e.g. to display a warning message that suspends the previous display).

In response to the request to suspend processing of the current processing task, data which is to be saved in response to the request to suspend processing is saved from the working memory resource to the main memory resource. The data to be saved is in an embodiment data which has been changed or created (e.g. as a result of the processing operations of the processing task which have been completed up to that point) during the processing of the task which is to be suspended.

According to the technology described herein, the command stream, which comprises a sequence of commands (instructions) for performing operations for a given processing task, also comprises one or more data save indicators that indicate data that is to be saved. The data save indicators that are used in the technology described herein may take any suitable and desired form. A (and each) data save indicator in an embodiment indicates data that has been created or changed up to a point in the execution of the sequence of commands of the command stream that precedes the data save indicator in the command stream and which should desirably be saved in the event of the processing task being suspended at or after the position of the data save indicator in the command stream.

In an embodiment, a data save indicator indicates the memory location(s) of data that should desirably be saved. In an embodiment, a data save indicator is in the form of a table which associates respective ones of a plurality of different blocks (regions) of the working memory with indications of whether the contents of each such block of working memory should be saved to main memory (that is, the data save indicator in an embodiment indicates which blocks of working memory contain data that will have been changed or created and has yet to be saved back to main memory).

To simplify the form of a data save indicator, the various blocks of working memory may be referenced indirectly in the data save indicator. That is, instead of listing the addresses contained within each block of memory, a data save indicator may contain a reference (an index) for each block of working memory. In an embodiment, a different table (e.g. a memory table) can be used to associate respective references with respective sets of memory addresses. The data save indicator(s) can then use the reference associated with a respective set of memory addresses instead of listing out all of the memory addresses contained in that set of memory addresses. In this way, the data save indicators can be made more compact.

A data save indicator may be located in any suitable and desired location within a command stream. In an embodiment, plural data save indicators are provided within a command stream. The plural data save indicators may be included in the command stream at regular or irregular intervals. Determination of data save indicator locations is discussed in more detail below.

Where plural data save indicators are provided, these may all have the same form or they may have different forms. In an embodiment, a data save indicator has a standard form such that where plural data save indicators are provided they all have the same form but may, and in an embodiment do, indicate different data to be saved.

In an embodiment, in response to a request to suspend processing of the current processing task, a save interrupt handler is initiated. The save interrupt handler may be executed as a separate command stream from the command stream of the processing task which is to be suspended. The save interrupt handler causes data indicated by the data save indicator to be saved from the working memory resource associated with the processing resource to the main memory resource associated with the host processor. The save interrupt handler also causes an indication of the location in the command stream of the processing task at which processing has been suspended to be saved to the main memory resource. In this way, in the event that processing of the suspended task is resumed, it is possible to look up in the main memory resource the location at which the previously suspended task should be resumed. In an embodiment, saving data from the working memory resource to the main memory resource is implemented as one or more direct memory access (DMA) operations.

The processing of the current processing task may be suspended immediately once the request to suspend processing of the current processing task is received (at or after the execution of the current command). However, in an embodiment, the execution of the command stream is only suspendable (and suspended) at certain points in execution of the command stream. To facilitate this, the command stream accordingly in an embodiment (additionally) comprises one or more “permitted suspend” indicators, that indicate where in the command stream a processing task may be suspended.

In an embodiment, in response to a request to suspend processing of a current processing task, the processing of the current processing task continues until the next “permitted suspend” point (indicator) is reached. Upon reaching the next permitted suspend point (indicator), processing of the current processing task is suspended and the data indicated in the most recent (preceding) data save indicator is saved from the working memory to the main memory. If the permitted suspend indicator coincides with a data save indicator then it is in an embodiment that data save indicator which is used to determine the data that should be saved out to main memory. The permitted suspend indicator may not coincide with a data save indicator, however. In this case, the data save indicator which was the last to be reached in the command stream is in an embodiment the one which determines the data that should be saved out to main memory.

As well as saving out data based on a data save indicator in the command stream when a processing task is suspended, in an embodiment the point (e.g., and in an embodiment, the suspend point) in the command stream at which processing was suspended is also saved (tracked) so that it can be later determined at which point the processing was suspended.

A permitted suspend indicator may be located in any suitable and desired location within a command stream. In an embodiment, plural permitted suspend indicators are provided within a command stream. The plural permitted suspend indicators may be included in the command stream at regular or irregular intervals. In an embodiment, each of the plural permitted suspend indicators coincides with a respective data save indicator. Determination of permitted suspend indicator locations is discussed in more detail below.

When a command stream for a processing task is being executed, the processing of the processing task may be suspended (but does not have to be) upon reaching a permitted suspend indicator. In an embodiment, if no request to suspend the processing task has been received, processing of the processing task continues beyond the permitted suspend indicator that has been reached. Conversely, if a request to suspend the processing task has been received, the processing of the processing task is suspended at the permitted suspend indicator.

The request to suspend the current processing task may comprise a request to switch to a different processing task. Performance of the current processing task is in an embodiment suspended in response to a request to switch to the different processing task. This may occur because it is necessary to suspend the current processing task in order to process the different processing task.

In this case, upon receiving a request to switch from processing a current processing task to processing a different processing task, the processing resource in an embodiment continues to process the current processing task until the next permitted suspend indicator in the command stream is reached. When the next permitted suspend indicator in the command stream is reached, processing of the current task is suspended and the data indicated by the relevant data save indicator is saved from working memory to main memory. Once the data indicated by the data save indicator is saved to main memory, the processing resource can begin processing the different processing task. To do this, the processing resource is provided with a command stream that causes the processing resource to perform processing operations for the different processing task.

The command stream for the different processing task may also comprise one or more data save indicators and one or more permitted suspend indicators as described above. Processing of the different processing task may continue until a request to suspend the processing of that processing task is received (or the task is finished). In this case, the process to suspend the different processing task works in the same way. That is, in response to a request to suspend processing of the different processing task, the processing of that processing task in an embodiment continues until the next permitted suspend indicator is reached. Processing of the different processing task is then suspended and the data indicated by the most recent data save indicator is saved to main memory.

Alternatively, the command stream for the different processing task may not comprise one or more data save indicators and one or more permitted suspend indicators (e.g. if the processing of the different processing task is not predictable such that data which will be created or changed cannot be indicated in advance). In this case, data which is changed or created during processing of the different processing task may (if desired) be tracked in other ways. For example, “dirty bits” may be used to track data which should be saved.

After switching to processing the different processing task, a request to suspend processing of that processing task may be received. As described above, the request to suspend processing of the processing task may comprise a request to switch to another processing task. In that case, switching to another task may proceed as already described.

Once a processing task has been suspended in the manner of the technology described herein, then it may be desired to resume processing of that previously suspended processing task. This may be, and is in an embodiment, triggered by an appropriate request to resume processing of the suspended process task.

The request to resume processing of a suspended processing task can take any suitable and desired form. The request can be and is in an embodiment any request that explicitly or implicitly indicates or should be taken as indicating, a need to resume processing of a processing task. It is in an embodiment in the normal form for such requests in the data processing system in question, and may be triggered for any suitable and desired reason, such as, and in an embodiment, the existing reasons as to why suspended processing tasks may be resumed in the data processing system in question.

In one embodiment, the request to resume processing of the processing task is in the form of a request to switch to processing the processing task in question.

When resuming a previously suspended processing task, the appropriate command stream for the processing task (which is in an embodiment the command stream originally provided for the processing task) is in an embodiment provided to the processing resource, with the processing resource then resuming the processing task by resuming execution of the command stream in an appropriate manner. Again, this may be, and is in an embodiment, done in the normal manner for resuming processing tasks and the execution of command streams in the data processing system in question.

The processing of the resumed processing task is in an embodiment resumed at an appropriate point in (the command stream of) the processing task (rather than simply from the beginning again) (e.g., and in an embodiment, based on a record of the point at which the task was suspended as discussed above).

Thus, in the case where the execution of the command stream is only suspendable at certain “permitted suspend” points in execution of the command stream, the resumption of the command stream execution is in an embodiment done from (or at least based on) the “permitted suspend” point at which the command stream execution was previously suspended. Thus, upon receiving a request to resume processing a processing task the processing resource in an embodiment resumes the processing task at a (in an embodiment predetermined) point preceding (in an embodiment immediately preceding) the permitted suspend point at which the previous processing of the task was suspended, or at the permitted suspend point at which the previous processing of the task was suspended, or at a (in an embodiment predetermined) point after (in an embodiment immediately after) the permitted suspend point in the command stream at which the previous processing of the task was suspended.

It would additionally or alternatively be possible to include corresponding “permitted resume” points (and permitted resume point indicators) in a command stream. In this case, the resumption of the command stream execution is in an embodiment done from (at) the appropriate “permitted resume” point for the point at which the command stream execution was previously suspended (e.g., and in an embodiment, the permitted resume point immediately preceding the permitted suspend point at which the previous processing of the task was suspended.

The Applicants have recognised that when resuming a previously suspended processing task, it may be desirable to retrieve from memory data which will be required during the resumed execution of the previously suspended processing task, e.g. before or when resuming execution of the previously suspended processing task. In this way, the previously suspended processing task can be resumed, e.g. from the point at which it was suspended, without the need to repeat (some or all of) the execution of previous steps, e.g. which create or update data.

Thus, in response to a request to resume a previously suspended processing task, the processing resource in an embodiment retrieves data relating to that processing task from the main memory resource. In an embodiment, data which was created or changed during the previous processing of the processing task and which was saved into main memory when the processing task was suspended is retrieved from main memory and made available to the processing resource when the processing task is resumed. In this way, it may not be necessary to repeat previously performed operations such that the process of resuming a processing task is made more efficient.

In an embodiment the data which is to be restored when resuming processing of a processing task is loaded into the working memory resource from the main memory resource.

The data which is retrieved (restored) is in an embodiment data which will be needed for (during) the resumed processing of the task which has been suspended.

Once the data has been retrieved (restored), the processing resource can resume processing the processing task.

In an embodiment, in response to receiving a request to resume processing of a previously suspended processing task and prior to resuming processing of the previously suspended processing task, the working memory of the processing resource is first cleared (e.g. the values stored in all of the memory locations within the working memory are set to 0). This may be desirable, e.g., for security reasons. After the working memory has been cleared, the processing resource then resumes the processing of the previously suspended processing task (e.g. as set out above).

The data which is to be retrieved when resuming processing of a previously suspended processing task may be indicated (e.g. to the processing resource) in any suitable and desired manner.

In an embodiment, in response to a request to resume processing of a previously suspended processing task and before the processing task is resumed, a resume interrupt handler is initiated. The resume interrupt handler may be executed as a separate command stream from the command stream of the processing task which is to be resumed. The resume interrupt handler reads, from the main memory resource, data which indicates where in the command stream of the processing task to be resumed the processing task should be resumed. The resume interrupt handler also causes data which is required for the continuation of the processing task which is to be resumed to be retrieved from the main memory resource and restored to the working memory resource. In an embodiment, restoring (retrieving) data from the main memory resource to the working memory resource is implemented as one or more direct memory access (DMA) operations.

In one embodiment a data save indicator in the command stream (and in an embodiment the corresponding data save indicator that was used to determine the data to be saved when the processing task was suspended) is used to determine (and to indicate) the data to be retrieved (restored) when resuming processing of the command stream. Thus, in this case, the data to be retrieved when resuming processing of a processing task will be determined from the data save indicator that was used to determine the data to be saved out to main memory when suspending the processing task (which will in an embodiment be a data save indicator either that coincides with the permitted point in the command stream at which the processing was suspended, or the data save indicator which was the last to be reached in the command stream prior to the processing of the processing task being suspended).

In this case, the data save indicator can indicate the data to be retrieved in any suitable and desired manner, for example, and in an embodiment, in a corresponding manner to the way that the data to be saved is indicated.

The Applicants have recognised that not all of the data which was saved when a processing task was previously suspended may be required for the continued processing of the processing task when it is resumed. Thus, the data to be retrieved when a previously suspended processing task is resumed, may be, and in embodiments is, different to the data which was saved when the processing task was suspended.

In order to facilitate this, it would be possible, for example, for respective data save indicators to be configured so as both to indicate data to be saved when suspending a processing task and, separately, data to be retrieved when resuming the processing task. In this case, a data save indicator will effectively indicate both data to be saved and data to be retrieved.

It would alternatively or additionally (and in an embodiment additionally) be possible to include separate “data retrieval” indicators in a command stream to indicate data which is to be retrieved (from (main) memory) when resuming a previously suspended processing task, which data retrieval indicators would be separate to any data save indicators in the command stream.

Thus, in an embodiment, a “data retrieval” indicator or indicators may be and is (are) included in a command stream to indicate data which is to be retrieved from (main) memory when resuming the processing task (after it has been suspended).

Such data retrieval indicators may, and in an embodiment do, indicate data that is to be retrieved from (main) memory before a processing task is resumed, and in an embodiment can appropriately be identified as such (i.e. so as to distinguish them from data save indicators, for example).

A (and each) data retrieval indicator in an embodiment indicates data that should desirably be retrieved in the event of the processing task being resumed at or after the position of the data retrieval indicator in the command stream.

The data retrieval indicators may take any suitable and desired form.

Where used, the separate data retrieval indicators in an embodiment have a corresponding form to the data save indicators (as discussed above).

Thus, a data retrieval indicator in an embodiment indicates the memory location(s) of data that should be retrieved. In an embodiment, a data retrieval indicator is in the form of a table which associates respective ones of a plurality of different blocks (regions) of the memory with indications of whether the contents of each such block of memory should be retrieved.

To simplify the form of a data retrieval indicator, the various blocks of memory may be referenced indirectly in the data retrieval indicator. That is, instead of listing the addresses contained within each block of memory, a data save indicator may contain a reference (an index) for each block of memory. In an embodiment, a different table (e.g. a memory table) can be used to associate respective references with respective sets of memory addresses. The data retrieval indicator(s) can then use the reference associated with a respective set of memory addresses instead of listing out all of the memory addresses contained in that set of memory addresses. In this way, the data retrieval indicators can be made more compact.

Where plural data retrieval indicators are provided, these may all have the same form or they may have different forms. In an embodiment, a data retrieval indicator has a standard form such that where plural data retrieval indicators are provided they all have the same form but may, and in an embodiment do, indicate different data to be retrieved (restored).

A data retrieval indicator may be located in any suitable and desired location within a command stream. In an embodiment, plural data retrieval indicators are provided within a command stream. The plural data retrieval indicators may be included in the command stream at regular or irregular intervals.

In an embodiment, the data retrieval indicators are included in the command stream in association with a respective corresponding data save indicator, such that, and in an embodiment, for any given suspension (e.g. permitted suspend point) of a processing task, there will be both a data save indicator indicating data to be stored out when the task is suspended at that point, and an associated data retrieval indicator indicating data to be retrieved if the task is resumed at that point.

As discussed above, it may be that the data to be saved out and the data to be retrieved would be the same when a task is suspended at a given point, but that need not be the case, and in other embodiments the data to be retrieved (when the task is resumed) will comprise some but not all of the data to be saved (when the task is suspended). Equally, there may be some suspend points in the command stream for a processing task where the data to be saved and retrieved is the same, and other suspend points where the data to be saved and retrieved differs.

It will be appreciated that in embodiments in which the data to be retrieved when the processing task is resumed comprises some but not all of data which was to be saved when the processing task was previously suspended, there will still be some overlap in the indicated data such that the data to be retrieved when processing is resumed is (only) a subset of the data which was saved when the processing task was previously suspended. In other words, in some embodiments, some (but not all) of the data which was saved when the processing task was suspended is to be retrieved when the task is resumed.

The technology described herein also extends to the generation of command streams in the manner of the technology described herein.

Thus, a third embodiment comprises a method of generating a command stream for causing a processing resource operable to perform data processing operations for applications executing on a host processor to perform a processing task comprising one or more processing operations,
the method comprising including in the command stream:
   a sequence of commands for execution by a processing resource to cause the processing resource to perform processing operations for a processing task; and
   one or more data save indicators indicative of data that should be saved in the event of processing of the processing task being suspended.

A fourth embodiment comprises an apparatus for generating a command stream for causing a processing resource operable to perform data processing operations for applications executing on a host processor to perform a processing task comprising one or more processing operations,
the apparatus comprising:
   a processing circuit configured to generate a command stream for causing a processing resource operable to perform data processing operations for applications executing on a host processor to perform a processing task comprising one or more processing operations, wherein the processing circuit is configured to include in the command stream:
   a sequence of commands for execution by a processing resource to cause the processing resource to perform processing operations for a processing task; and
   one or more data save indicators indicative of data that should be saved in the event of processing of the processing task being suspended.

As will be appreciated by those skilled in the art, these embodiments of the technology described herein can, and in an embodiment do, include any one or more or all of the features of the technology described herein described herein, as appropriate.

Thus, for example, the data save indicators in an embodiment have the form discussed above. Correspondingly, the generation of the command stream in an embodiment further comprises including one or more permitted suspend point indicators and/or (and in an embodiment and) data retrieval indicators in the command stream, as well as the data save indicators.

The command stream is in an embodiment generated as part of an appropriate compilation process for the command stream. This may be done, for example, on the host processor when a processing task is required to be performed by the processing resource (e.g. by an appropriate driver for the processing resource that is executing on the host processor (and in one embodiment this is what is done)). Alternatively, the command stream could be generated in advance of its execution by the processing resource, for example in an “offline” manner. In this case, the command stream generation may still take place on the host processor, or it may be performed on a different processor to the host processor, and, for example, be stored in memory for provision by the host processor to the processing resource when required. Other arrangements would, of course, be possible.

Irrespective of how the command stream is generated, the appropriately prepared command stream should be, and is in an embodiment, provided to the processing resource for execution at the appropriate time.

In an embodiment, plural command streams are prepared, each command stream of the plural command streams configured to cause the processing resource to perform a respective (in an embodiment, different) processing task.

Including one or more data save indicators in the command stream in an embodiment comprises determining where to include one or more data save indicators in the command stream and then including a respective data save indicator at a (and in an embodiment each) determined location.

Determining where to include the one or more data save indicators in the command stream may be done in any suitable and desired manner. It is in an embodiment based on the processing task. In an embodiment, determining where to include one or more data save indicators in the command stream is based on what data will be created or changed during processing of the processing task. For example, it may be desirable to only include a data save indicator where there is new information to be indicated by that data save indicator. Thus, a data save indicator is in an embodiment only included in the command stream when (and after) there is a change in which data, e.g., and in an embodiment, memory blocks, should be saved in the event of a processing task being suspended. Conversely, if there is no change in which data, e.g. memory blocks, would need to be saved, even if a number of commands are present in the sequence of commands since the previous data save indicator was included, there may be no need or desire to include an additional data save indicator.

In an embodiment, determining where to include a data save indicator into the command stream comprises determining whether or not a condition has been satisfied. In an embodiment, the condition is based on whether or not a threshold has been met or exceeded.

In an embodiment, plural data save indicators are included in the command stream at regular intervals. For example, a respective data save indicator may be included in the command stream every 1, 10 or 100 commands, as appropriate to the command stream in question.

In an embodiment, data save indicators are distributed at irregular intervals throughout the command stream. For example, data save indicators may be included in the command stream based on the processing operations to be carried out when the command stream is executed. This may result in some data save indicators within the same command stream being separated by only one command and others being separated by plural commands, for example. In an embodiment, a data save indicator is included in a command stream when data will be changed or created in response to the preceding command in the command stream.

It would also be possible, for example, both to include data save indicators at regular intervals in the command stream together with other data save indicators that are distributed more irregularly throughout the command stream (e.g. because they are based on other “inclusion” conditions that may only be met at irregular intervals in the command stream).

As discussed above, in an embodiment, one or more permitted suspend indicators are also included in the command stream, the one or more permitted suspend indicators indicating where in the command stream the processing of the processing task may be suspended.

Including one or more permitted suspend indicators in the command stream in an embodiment comprises determining where to include one or more permitted suspend indicators in the command stream and then including a respective “permitted suspend” indicator at a (and each) determined location.

Determining where to include a permitted suspend indicator in the command stream can be done in any suitable and desired manner. In an embodiment, determining where to include a permitted suspend indicator in the command stream comprises determining whether or not a condition has been satisfied.

In an embodiment, the condition is based on whether or not a threshold has been reached or exceeded. The threshold may be any suitable and desired threshold.

The Applicants have realised that there is a trade off between an amount of data to be recomputed and an amount of data to be retrieved from memory in the event of a task being resumed. By inserting a permitted suspend indicator based on a particular threshold, it is possible to ensure a desired balance between these two considerations. It will be appreciated that the threshold can, and in an embodiment is, set based on the individual requirements of a particular processing task.

In an embodiment, the threshold is a memory threshold. For example, where it is known in advance which data will be changed or created during execution of the processing operations through the processing task, it may be desirable to set a threshold which indicates a certain amount of memory used to store the changed or created data. The memory threshold is in an embodiment expressed as a certain number of bytes of memory that will be used to store the changed or created data. When the memory threshold is reached, a permitted suspend indicator may be included in the command stream.

In another embodiment, the threshold is a number of commands threshold. For example, a permitted suspend indicator may be included if a certain number of commands has been included in the command stream since the start of the processing task or since a previous permitted suspend indicator was included.

In another embodiment, the threshold is a time threshold, which is based on a length of time required to perform one or more commands in the command stream. For example, if it is known that a particular command or set of commands (e.g. a set of commands that are all related to a particular sub-processing task of the processing task being performed) will exceed a particular time threshold, it may be desirable to include a permitted suspend indicator prior to (in an embodiment immediately prior to) that command or set of commands.

In a further embodiment, the condition is based on the operations to be performed when the command stream is executed. As mentioned above, this may be a length of time taken to perform certain operations, and/or whether the operation will update or create data. In an embodiment, the condition relates to the actual operation(s) performed.

In an embodiment, determining where to include one or more permitted suspend indicators is also or instead (and in an embodiment also) based on hardware considerations, such as a property or properties of the hardware that the command stream will be executed on, and/or of the memory system of the data processing system in question.

As discussed above, in an embodiment one or more data retrieval indicators are also included in the command stream, the one or more data retrieval indicators indicating data to be retrieved when processing of the processing task is resumed (after previously being suspended).

Including one or more data retrieval indicators in the command stream in an embodiment comprises determining where to include one or more data retrieval indicators in the command stream and then including a respective data retrieval indicator at a (and in an embodiment each) determined location.

Determining where to include the one or more data retrieval indicators in the command stream may be done in any suitable and desired manner.

As discussed above, in an embodiment, where data retrieval indicators are used, then in an embodiment such indicators are provided in association with corresponding data save indicators, such that the data retrieval indicators may be, and are in an embodiment, included in the command stream in combination with (at the same locations as) the respective data save indicators that are included in the command stream.

Correspondingly, the considerations for where to include a data retrieval indicator in the command stream should, and in an embodiment do, correspond to the considerations for determining where to include the data save indicator in a command stream.

Thus, determining where to include one or more data retrieval indicators in the command stream is in an embodiment based on the processing task, and in an embodiment based on what data will be created or changed during processing of the processing task. For example, it may be desirable to only include a data retrieval indicator where there is new information to be indicated by that data retrieval indicator. Thus, a data retrieval indicator is in an embodiment only included in the command stream when (and after) there is a change in which data, e.g., and in an embodiment, memory blocks, should be retrieved (restored) in the event of a processing task being resumed.

In an embodiment, determining where to include a data retrieval indicator into the command stream comprises determining whether or not a condition has been satisfied. In an embodiment, the condition is based on whether or not a threshold has been met or exceeded.

In an embodiment, plural data retrieval indicators are included in the command stream at regular intervals. For example, a respective data retrieval indicator may be included in the command stream every 1, 10 or 100 commands, as appropriate to the command stream in question.

In an embodiment, data retrieval indicators are also or instead distributed at irregular intervals throughout the command stream. For example, data retrieval indicators may be included into the command stream based on the processing operations to be carried out when the command stream is executed. In an embodiment, a data retrieval indicator is included in a command stream when data will be changed or created in response to the preceding command in the command stream and will be required in the further execution of the command stream (when resumed after being suspended).

The technology described herein also extends to the execution of command streams in the manner of the technology described herein.

Thus, another embodiment of the technology described herein comprises a method of operating a processing resource of a data processing system, the processing resource operable to perform data processing operations for applications executing on a host processor of the data processing system;
the method comprising the processing resource:
   executing commands in a command stream provided to the processing resource to cause the processing resource to perform a processing task comprising one or more processing operations;
   and
   in response to the processing resource receiving a request to suspend processing of the processing task being performed:
      storing in a main memory resource of the data processing system data indicated by a data save indicator in the command stream, the data save indicator indicating data that is to be saved.

Another embodiment of the technology described herein comprises a processing resource operable to perform data processing operations for applications executing on a host processor of a data processing system,
the processing resource comprising:
   a circuit configured to execute commands in a command stream received by the processing resource to perform processing operations for a processing task; and
   a circuit configured to:
      in response to the processing resource receiving a request to suspend processing of a processing task being performed:
         store in a main memory resource of the data processing system, data indicated by a data save indicator in a command stream being executed, the data save indicator indicating data that is to be saved.

As will be appreciated by those skilled in the art, these embodiments of the technology described herein can, and in an embodiment do, include any one or more or all of the features of the technology described herein described herein, as appropriate.

Thus, for example, the data which is to be saved in response to the request to suspend processing is in an embodiment saved from a working memory resource of the processing resource to the main memory resource. The data that is saved is in an embodiment data which has been changed or created (e.g. as a result of the processing operations of the processing task which have been completed up to that point) during the processing of the task which is to be suspended.

Correspondingly, in an embodiment, in response to a request to suspend processing of a current processing task, the processing of the current processing task is continued until a next “permitted suspend” point (indicator) in the command stream is reached. In an embodiment, upon reaching the next permitted suspend point (indicator), processing of the processing task is suspended and the data indicated in a (and in an embodiment the most recent) (preceding) data save indicator is saved to the main memory.

As well as saving out data based on a data save indicator in the command stream when the processing task is suspended, in an embodiment the point (e.g., and in an embodiment, the suspend point) in the command stream at which processing was suspended is also saved (tracked).

In an embodiment, the method further comprises (and the processing resource is operable to) resuming processing of a (the) previously suspended processing task, in an embodiment in response to a request to resume processing of the suspended processing task.

The resuming of a previously suspended processing task in an embodiment comprises resuming execution of the command stream for the processing task, e.g., and in an embodiment, at an appropriate point in the command stream, such as, and in an embodiment, at or after the point in the command stream at which the previous processing of the task was suspended.

Similarly, when resuming a previously suspended processing task the processing resource in an embodiment retrieves data relating to that processing task from the main memory resource (for use by the processing resource when the processing task is resumed).

In an embodiment the data which is to be restored when resuming processing of a processing task is loaded into the working memory resource from the main memory resource.

In an embodiment the data which is retrieved (restored) when resuming processing of a previously suspended processing task is based on a data save and/or data retrieval indicator in the command stream.

In an embodiment, the data retrieved when resuming a previously suspended processing task is different to the data which was saved when the processing task was suspended.

The technology described herein can be implemented in any suitable system, such as a suitably configured microprocessor-based system. In embodiments, the technology described herein is implemented in a computer and/or microprocessor-based system. The technology described herein is in embodiments implemented in a portable device, such as, and in embodiments, a mobile phone or tablet.

In embodiments, the various functions of the technology described herein are carried out on a single data processing platform that generates and outputs data, for example for a display device.

The host processor will send appropriate commands and data to the processing resource to control it to perform processing operations and to produce processing output required by applications executing on the host processor. To facilitate this, the host processor should, and in embodiments does, also execute a driver for the processing resource and optionally a compiler or compilers for compiling command streams to be executed by the processing resource.

The processing resource may also comprise, and/or be in communication with, one or more memories and/or memory devices that store the data described herein, and/or store software for performing the processes described herein. The processing resource and/or host processor may also be in communication with a display for displaying images based on data generated by the processing resource.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the components of the data processing system can otherwise include any one or more or all of the usual functional units, etc., that such components include.

It will also be appreciated by those skilled in the art that all of the described embodiments of the technology described herein can include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a processor, renderer or microprocessor system comprising data processor causes in conjunction with said data processor said processor, renderer or microprocessor system to carry out the steps of the methods of the technology described herein. Such a computer software carrier could be a non-transitory physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

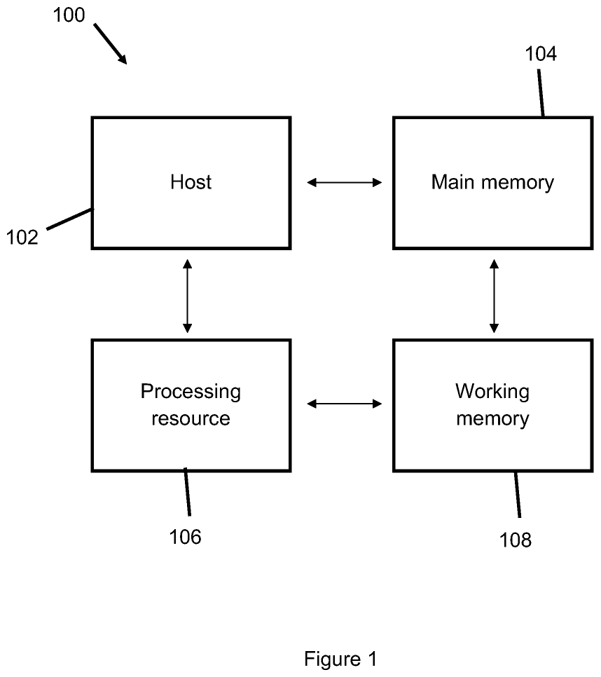

FIG. 1 schematically shows a data processing system 100 that can be operated according to the technology described herein. The data processing system 100 comprises a host processor 102, which has an associated main memory resource 104. The host processor 102 is in an embodiment a central processing unit (CPU). The system 100 also comprises a processing resource 106, such as a graphics processor (GPU) or neural processor (NPU), which has an associated working memory resource 108.

The host processor 102 is operable to provide one or more command streams to the processing resource 106 for execution by the processing resource 106. The processing operations may be any suitable and desired processing operations that can be carried out by the processing resource. This may, and in an embodiment does, depend on the nature of the processing resource. For example, the processing task may be an image processing task, an image compression task, an image decompression task or a neural network processing task, as appropriate.

In an embodiment, the one or more command streams to be provided to the processing resource 106 are generated by the host processor 102 and provided directly to the processing resource 106 for execution. In another embodiment, the one or more command streams are stored in the main memory resource 104 associated with the host processor 102. In that case, the host processor 102 retrieves the one or more command streams to be provided to the processing resource 106 from the main memory resource 104 before providing the one or more command streams to the processing resource 106.

The one or more command streams provided by the host processor 102 may be stored in the working memory resource 108 associated with the processing resource 106 after being provided to the processing resource 106.

Each command stream comprises commands (instructions) to set parameters for data processing tasks, as well as commands (instructions) to perform a data processing task. The processing resource 106 executes the commands in the command stream in order to perform the data processing task.

In addition to receiving data from the host processor 102, the processing resource 106 can send data to the host processor 102 and/or to the main memory resource 104 associated with the host processor 102.

It may be desirable to suspend processing of a current processing task by the processing resource 106. In the event that a request to suspend processing of the current processing task is received, the processing resource 106 saves data from the working memory resource 108 to the main memory resource 104. For example, data which has been created or amended may be saved from the working memory resource 108 to the main memory resource 104. In this way, the data which has been created or amended as part of the suspended processing task can be saved for later retrieval and the working memory resource 108 (or a part thereof) associated with the processing resource 106 can be cleared for use in processing a different processing task.

If a previously suspended processing task is resumed, data which was created or changed during the previously completed processing operations of the suspended processing task can be retrieved from the main memory resource 104 in response to a request to resume the previously suspended processing task. This allows processing of the processing task to be resumed as close as possible to, and in an embodiment at, the point at which the processing was previously suspended. Suspending and resuming processing tasks will be described in more detail below.

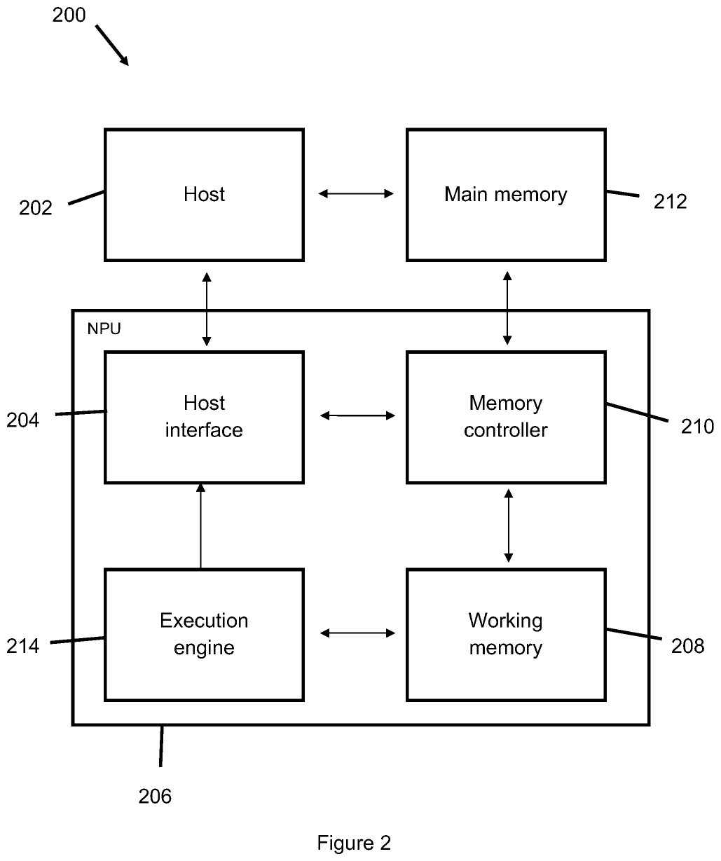

FIG. 2 schematically shows another data processing system 200 that can be operated according to the technology described herein. The data processing system 200 comprises a host processor 202 connected to a host interface 204 of a processing resource (NPU) 206 configured to perform neural network processing. The NPU 206 also comprises a working memory resource 208 connected to a memory controller 210. The memory controller 210 is also communicatively connected to a main memory resource 212 of the host processor 202. The NPU 206 comprises an execution engine 214 configured to execute neural network processing. The host processor 202 is configured to provide one or more command streams to the NPU 206 for execution by the NPU 206.

Again, the one or more command streams to be provided to the NPU 206 may be generated by the host processor 202 and provided directly to the NPU 206 for execution, and/or one or more command streams are stored in the main memory resource 212 associated with the host processor 202, with the host processor 202 retrieving the command streams from the main memory resource 212 before providing the command streams to the NPU 206.

The one or more command streams provided by the host processor 202 may be stored in the working memory resource 208 associated with the NPU 206 after being provided to the NPU 206.

Each command stream comprises commands (instructions) to set parameters for data processing tasks, as well as commands (instructions) to perform a data processing task. The NPU 206 executes the commands in the command stream in order to perform the data processing task.

In addition to receiving data from the host processor 202, the NPU 206 can send data to the host processor 202 and/or to the main memory resource 212 associated with the host processor 202.

It may be desirable to suspend processing of a current processing task by the NPU 206. In the event that a request to suspend processing of the current processing task is received, the NPU 206 saves data from the working memory resource 208 to the main memory resource 212. For example, data which has been created or amended may be saved from the working memory resource 208 to the main memory resource 212. In this way, the data which has been created or amended as part of the suspended processing task can be saved for later retrieval and the working memory resource 208 (or a part thereof) associated with the NPU 206 can be cleared for use in processing a different processing task.

If a previously suspended processing task is resumed, data which was created or changed during the previously completed processing operations of the suspended processing task can be retrieved from the main memory resource 212 in response to a request to resume the previously suspended processing task. This allows processing of the processing task to be resumed as close as possible to, and in an embodiment at, the point at which the processing was previously suspended.

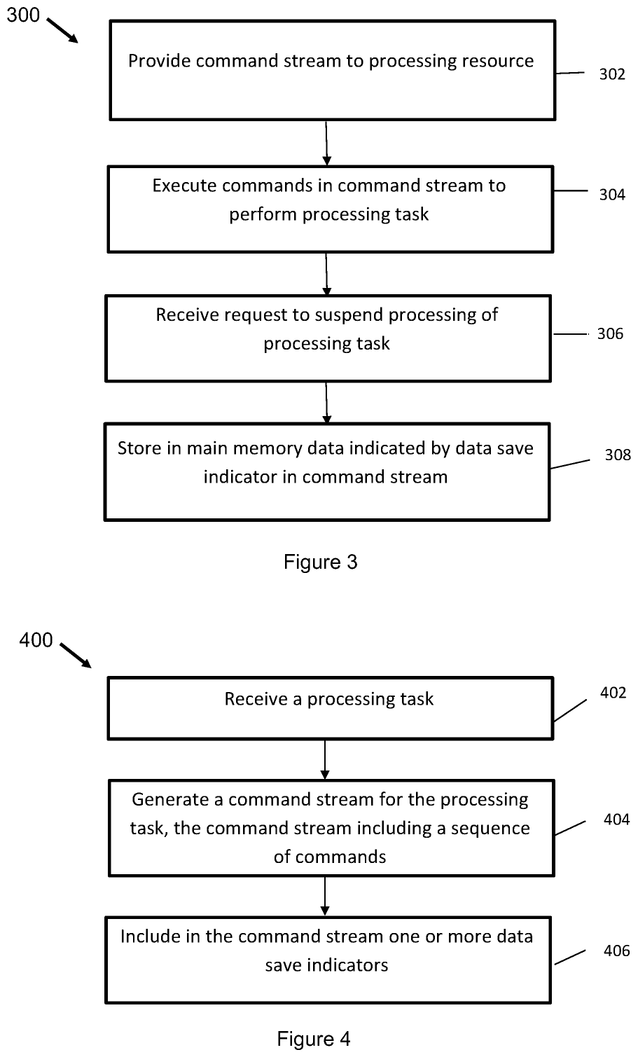

FIG. 3 shows a method 300 of operating a data processing system in an embodiment of the technology described herein. In a first step 302, a host processor of the data processing system provides, in response to a request for processing to be performed by the processing resource from an application executing on the host processor, a command stream to the processing resource to cause the processing resource to perform a processing task comprising one or more processing operations.

The command stream comprises a sequence of commands for execution by the processing resource to cause the processing resource to perform the processing operations for the processing task. The command stream also comprises one or more data save indicators that indicate data that is to be saved.

In a second step 304, the processing resource executes the commands in the command stream to perform the processing operations for the processing task.

In a third step 306, the processing resource receives a request to suspend processing of the processing task being performed.

In a fourth step 308, in response to receiving the request to suspend processing of the processing task being performed, the processing resource causes data indicated by one of the one or more data save indicators in the command stream to be saved in a main memory resource associated with the host processor.

The technology described herein also extends to generating a command stream. FIG. 4 shows a method 400 of generating a command stream in an embodiment of the technology described herein.

The method 400 comprises for a processing task that a processing resource is to perform, preparing a command stream to cause the processing resource to perform the processing task (step 402), the command stream comprising a sequence of commands for execution by the processing resource to cause the processing resource to perform the processing operations for the processing task; and including the command stream one or more data save indicators (step 404), the one or more data save indicators indicating which data should be saved in the event of processing of the processing task being suspended.

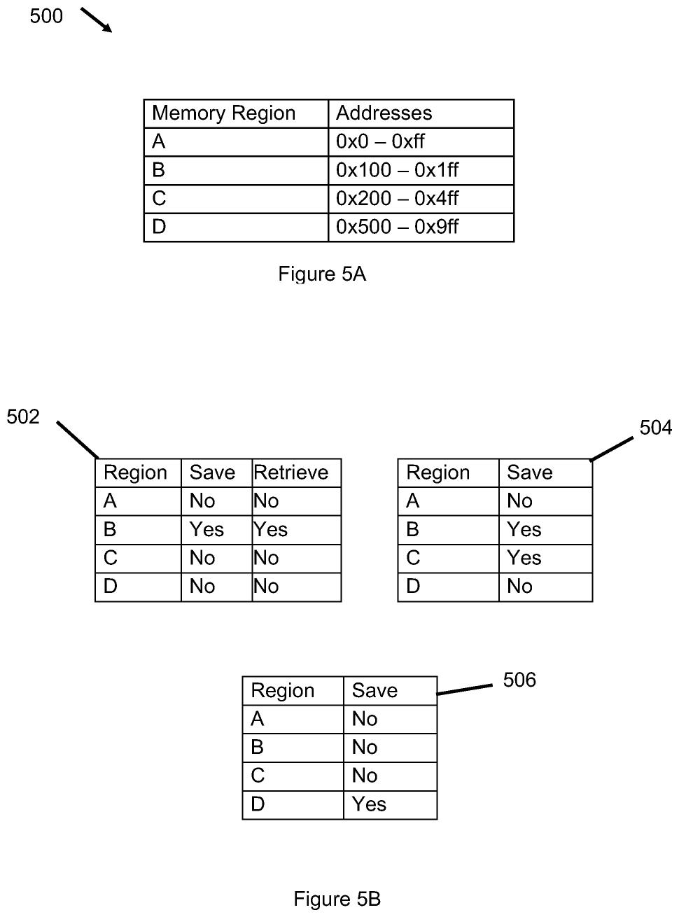

The data save indicators in the present embodiments indicate the memory location(s) of data that should be saved. To simplify the form of a data save indicator, the various blocks of working memory are referenced indirectly in the data save indicators. FIG. 5 illustrates this.

FIG. 5A shows a memory table 500 used in an embodiment. The memory table 500 maps memory regions A, B, C, D to blocks of memory addresses. In the example shown in the figure, addresses from 0x0 to 0xff have been designated as region A, addresses from 0x100 to 0x1ff have been designated as region B, addresses from 0x200 to 0x4ff have been designated as region C, and addresses from 0x500 to 0x9ff have been designated as region D.

It will be appreciated that the memory table 500 is given by way of example only. In other embodiments, the number of regions designated in a given memory table may be different. For example, in some embodiments, only two memory regions may be designated while in other embodiments, five, ten or even more memory regions may be designated depending on circumstances. In an embodiment, the greater the number of memory addresses, the greater the number of memory regions are designated. In an embodiment, the number of memory regions is selected based on the particular processing task or processing tasks to be performed by the data processing system.

FIG. 5B shows exemplary data save indicators and a data retrieval indicator that may be used in embodiments of the technology described herein. The memory table 500 makes it possible to simplify the format of a data save indicator, such as those shown in FIG. 5B. Instead of referring to one or more specific memory addresses, the data save indicators 502, 504, 506 in FIG. 5B refer to memory regions (i.e. as indicated in the memory table) and indicate whether or not data stored at the addresses which have been mapped to particular regions should be saved. That is, the data save indicators indicate which blocks of working memory contain data that has been changed or created and has yet to be saved back to main memory.

It can be seen in FIG. 5B that the data save indicators 502, 504, 506 all have the same format of a table which associates respective ones of a plurality of different (working) memory regions with indications of whether the contents of each memory region should be saved to main memory in the event of a processing task being suspended. It will be appreciated, however, that data save indicators may take other formats. It will further be appreciated that different ones of the data save indicators in a given command stream may take different formats.

The data save indicator 502 also comprises a data retrieval indicator in the form of an additional column in the table that associates data that is to be saved out to main memory from respective ones of a plurality of different working memory regions in the event of the processing task being suspended with indications of whether the data saved out from those memory regions should be restored in the event of the previously suspended processing task being resumed.

It will of course be appreciated that, in other embodiments, data retrieval indicators can take other forms. It will further be appreciated that respective data retrieval indicators do not necessarily have to be co-located with respective data save indicators but instead may be included in the command stream at locations that are independent of the locations of data save indicators.

The data save indicators 502, 504, 506 are included in the command stream at different locations. Determining where to include a data save indicator into a command stream is discussed in more detail below.

Processing of a current processing task may be suspended immediately once a request to suspend processing of the current processing task is received (at or after the execution of the current command). However, in an embodiment, the execution of the command stream is only suspended at certain points. In this case, the command stream additionally comprises one or more “permitted suspend” indicators. These indicate where in the command stream a processing task may be suspended.

When a command stream for a current processing task is being executed, the processing of the current processing task may be suspended (but does not have to be) upon reaching a permitted suspend indicator. If no request to suspend the current processing task has been received, processing of the current processing task continues beyond the permitted suspend indicator that has been reached. Conversely, if a request to suspend the current processing task has been received, the processing of the current processing task is suspended at the permitted suspend indicator.

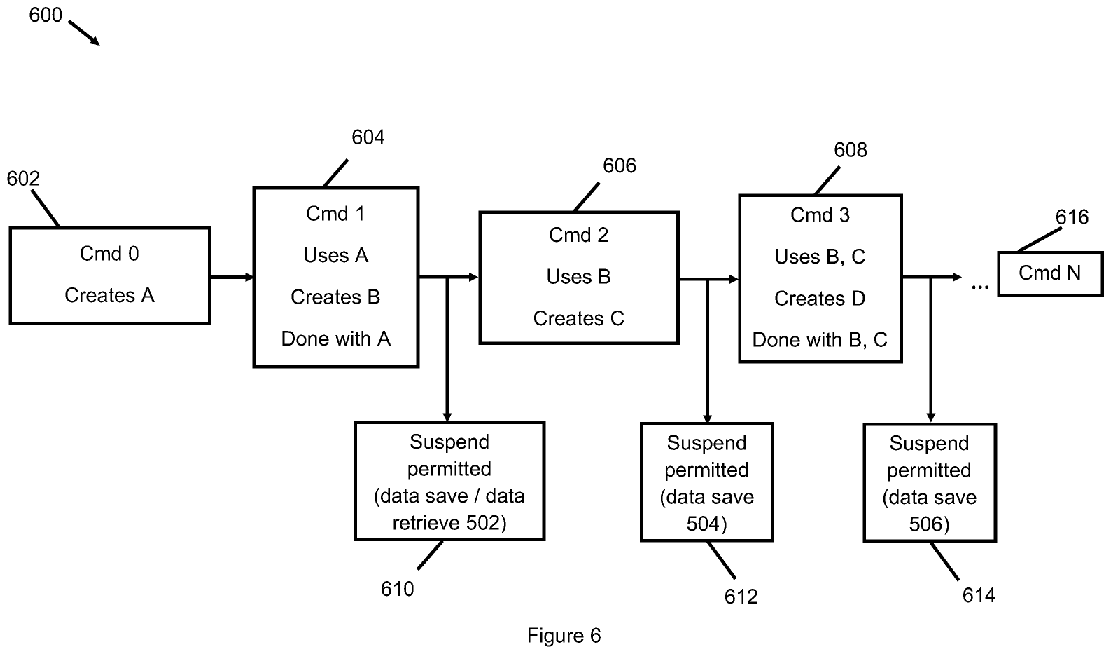

FIG. 6 schematically shows an embodiment of a command stream 600 for use with the technology described herein. The command stream 600 comprises a number of sequential commands 602, 604, 606, 608, 616. Respective permitted suspend indicators 610, 612, 614 are included in the command stream immediately following the second, third and fourth commands 604, 606, 608. The permitted suspend indicators 610, 612, 614 are respectively associated with the data save indicators 502, 504, 506 of FIG. 5B.

In the event that a request to suspend the processing task which is performed by executing the command stream 600 is received prior to the first permitted suspend point 610 (e.g. between the zeroth command 602 and the first command 604), the processing resource continues to execute the command stream 600 until the first permitted suspend point 610 is reached. In the illustrated example, the processing resource creates data in memory region A as a result of the zeroth command 602 and then uses this data in processing the first command 604. Processing the first command 604 results in created data being saved in memory region B. At this point, it is also known that the previously created data saved in memory region A is no longer needed for the further execution of the processing task.

Once the first permitted suspend indicator 610 is reached, the first data save indicator 502 associated with the first permitted suspend indicator 610 is consulted to determine which regions of working memory should be saved back to main memory. The first data save indicator 502 (FIG. 5B) indicates that only the data stored in memory region B of the working memory should be saved. The data stored in memory region B is saved to the main memory associated with the host processor. Once the data stored in memory region B of the working memory is saved in the main memory associated with the host processor, all regions of the working memory are available to be used (that is, any data still saved in the working memory can be overwritten) for processing the next processing task.

In contrast, if no request to suspend the current processing task is received, processing of the command stream 600 continues past the first permitted suspend indicator 610. The processing resource continues executing the commands 606, 608, 616 in sequence until a request to suspend the current processing task is received or the current processing task is completed.

In the event that a request to suspend processing of the current processing task is received once the processing resource has begun processing the second command 606, the processing continues until the second command 606 has been completed and the second permitted suspend indicator 612 is reached. The second command 606 uses data saved in memory region B and also creates data which is saved in memory region C. When the second permitted suspend indicator 612 is reached, the data indicated in the second data save indicator 504 associated with the second permitted suspend indicator 612 is saved to the main memory associated with the host processor. The second data save indicator 504 indicates that the data saved in memory regions B and C should be saved to main memory. This data will be used in the further execution of the command stream 600 (e.g. in the third command 608).

If no request to suspend processing of the current processing task is received prior to the second permitted suspend indicator 612, execution of the command stream 600 continues to the third command 608, which uses data stored in memory regions B and C, and creates new data which is saved in memory region D. A request to suspend processing received once the processing resource has begun processing the third command 608 will cause the processing to be suspended upon reaching the third permitted suspend indicator 614. The third data save indicator 506 which is associated with the third permitted suspend indicator 614 indicates that only data which is saved in memory region D needs to be saved to main memory in the event of a processing task suspension at the third permitted suspend indicator 614. As such, any data saved in regions A, B and/or C of the working memory is not saved back to main memory in the event of a processing task being suspended at the third permitted suspend indicator 614.

It will be appreciated that further permitted suspend indicators may be included at other points between the third command 608 and the Nth command 616 in the command stream 600.

In the above embodiment, each permitted suspend indicator is associated with a respective data save indicator. However, this is not essential, and they need not be associated with a respective data save indicator. In general, in the event of a request to suspend a processing task being received, the most recent data save indicator (in the command stream) is used to determine which memory regions should be saved to main memory. For example, if the most recent data save indicator is the third data save indicator 506 then only data saved in working memory region D will be saved to the main memory associated with the host processor. If, however, a more recent data save indicator indicates that the data stored in a different memory region or regions should be saved, then the data saved in that region or regions is saved.

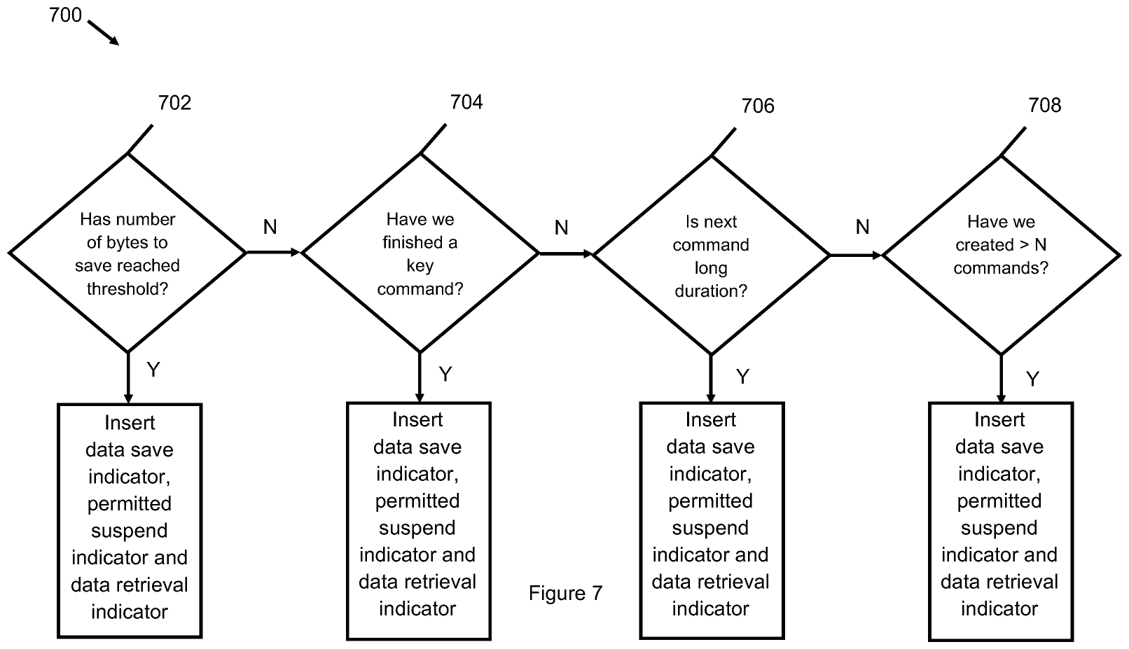

FIG. 7 shows a flowchart for determining locations of data save indicators, permitted suspend indicators and data retrieval indicators in an embodiment. The method comprises a series of decision steps 702, 704, 706, 708. Although the decision steps are illustrated in a particular order in FIG. 7, it will be appreciated that these may be carried out in any arbitrary order. Depending on the application, fewer or more decision steps may be carried out. For example, in certain embodiments, only some of the steps 702, 704, 706, 708 are performed. In other embodiments, all of the illustrated steps 702, 704, 706, and 708 are performed, optionally along with one or more additional decision steps (not shown) as appropriate to the application in question.

It will be appreciated that in other embodiments, an (and in an embodiment each) indicator (i.e. data save indicator, permitted suspend indicator and/or data retrieval indicator) can be included in the command stream without another indicator being included in combination with (at the same location as) the indicator.

Each of the steps 702, 704, 706, 708 determines whether or not a particular condition has been satisfied. If the condition is satisfied, a permitted suspend indicator is inserted into the command stream. In an embodiment, the condition is based on whether or not a threshold has been reached or exceeded.

The first step 702 of the method depicted in FIG. 7 determines whether or not the number of bytes of data to be saved has reached a given threshold. Where it is known in advance which data will be changed or created during execution of the processing operations through the processing task, a threshold is set which indicates a certain amount of memory used to store the changed or created data. The memory threshold may be expressed as a certain number of bytes of memory that will be used to store the changed or created data. The threshold may be set to any value appropriate to the processing task in question. If it is determined in step 702 that the threshold has been reached, a data save indicator, a permitted suspend indicator and a data retrieval indicator are inserted into the command stream. If it is determined that the threshold has not been reached, the method continues to step 704.

In step 704, it is determined whether or not a command of a particular type or types (a “key command”) has finished. If so, a permitted suspend indicator and a data retrieval indicator are inserted into the command stream; if not, the method continues to step 706.

In step 706, it is determined whether the next command will be of long duration. The threshold for determining “long duration” may be set to any appropriate value according to requirements and, in particular, may be different for different processing tasks. If the next command is determined to be of long duration, a data save indicator, a permitted suspend indicator and a data retrieval indicator are inserted into the command stream; otherwise, the method continues to step 708.

In step 708, it is determined whether or not the number of commands since the start of the command stream or since the previous permitted suspend indicator has reached a given threshold. The threshold may be set to any appropriate value. If is determined that the threshold has been reached, a data save indicator, a permitted suspend indicator and a data retrieval indicator are inserted into the command stream; if not, no such indicators are included at that point.

As mentioned above, other determinations may be made in order to insert permitted suspend indicators into a command stream, for example based on the processing tasks to be performed.

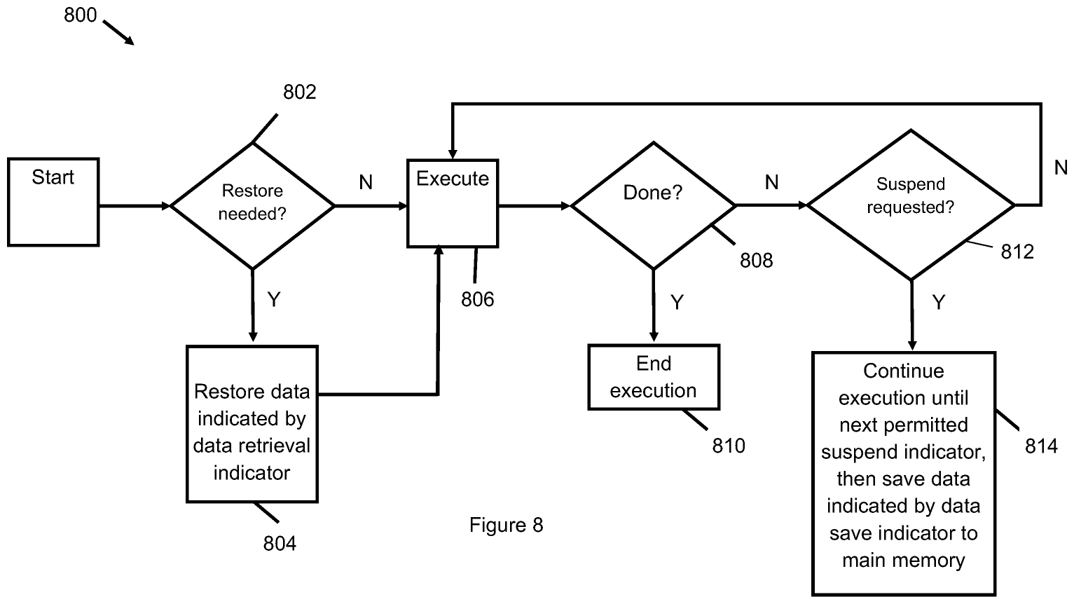

FIG. 8 shows a method 800 of resuming processing of a previously suspended processing task in an embodiment.

In response to a request to resume processing a previously suspended processing task, it is determined in a first step 802 whether or not it is necessary to restore data from a main memory resource to a working memory resource in order to process the resumed processing task. To do this, the processing resource determines whether the command stream of the previously suspended processing task (i.e. the command stream of the processing task which is to be resumed) includes at least one data retrieval indicator that indicates that (and which) data should be retrieved prior to resuming performance of the processing task (resuming execution of the commands in the command stream).

If it is determined that data does need to be restored in order to process the resumed processing task, the data indicated by the data retrieval indicator is restored 804 from a main memory resource to a working memory resource. The method then proceeds to resume executing 806 the resumed processing task.

If, however, it is determined that no data needs to restored in order to resume the processing task, the method proceeds directly to the execution step 806. Execution of the processing task continues until either the processing task is completed (step 808) or a request to suspend processing of the processing task is received (step 812).

If the processing of the processing task is completed, execution of the processing task is ended (step 810).

If a request to suspend processing of the processing task is received, data is saved 814 to the main memory resource as has been described herein. If a request to suspend processing of the processing task has not been received, execution 806 of the processing task continues.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a data processing system that comprises:
a host processor;
a main memory resource associated with the host processor;
a processing resource operable to perform data processing operations for applications executing on the host processor; and
a working memory resource associated with the processing resource;
the method comprising:
providing, by the host processor, in response to a request for processing to be performed by the processing resource from an application executing on the host processor, a command stream to the processing resource to cause the processing resource to perform a processing task comprising one or more processing operations, the command stream comprising:
a sequence of commands for execution by the processing resource to cause the processing resource to perform the processing operations for the processing task; and
one or more data save indicators that indicate data that is to be saved;
executing, by the processing resource, the commands in the command stream to perform the processing operations for the processing task;
the method further comprising:
in response to the processing resource receiving a request to suspend processing of the processing task being performed:
storing in the main memory resource data indicated by one of the one or more data save indicators in the command stream.

2. The method of claim 1, wherein the processing task is a task that performs neural network processing.

3. The method of claim 1, wherein at least one of the one or more data save indicators is in the form of a table which associates respective ones of a plurality of different blocks of working memory in the working memory resource with indications of whether the contents of each block of working memory should be saved to the main memory resource.

4. The method of claim 1, wherein the command stream additionally comprises one or more permitted suspend indicators which indicate where in the command stream the processing task is permitted to be suspended.

5. The method of claim 4, wherein, in response to a request to resume a previously suspended processing task, the processing resource retrieves from the main memory resource some or all of the data previously saved to the main memory resource when processing of the task which is to be resumed was suspended.

6. The method of claim 5, wherein the data retrieved when the processing task which is to be resumed is resumed comprises some but not all of the data which was saved to the main memory resource when the processing task which is to be resumed was suspended.

7. A data processing system comprising:
a host processor;
a main memory resource associated with the host processor;
a processing resource operable to perform data processing operations for applications executing on the host processor; and
a working memory resource associated with the processing resource;
the host processor comprising:
a circuit configured to provide, in response to a request for processing to be performed by the processing resource from an application executing on the host processor, a command stream to the processing resource to cause the processing resource to perform a processing task comprising one or more processing operations, the command stream comprising:
a sequence of commands for execution by the processing resource to cause the processing resource to perform the processing operations for the processing task; and
one or more data save indicators that indicate data that is to be saved;
the processing resource comprising:
a circuit configured to execute commands in a command stream received by the processing resource to perform processing operations for a processing task; and a circuit configured to:
in response to the processing resource receiving a request to suspend processing of a processing task being performed:
store in the main memory resource data indicated by a data save indicator in a command stream being executed.

8. The system of claim 7, wherein the processing task is a task that performs neural network processing.

9. The system of claim 7, wherein at least one of the one or more data save indicators is in the form of a table which associates respective ones of a plurality of different blocks of working memory in the working memory resource with indications of whether the contents of each block of working memory should be saved to the main memory resource.

10. The system of claim 7, wherein the command stream comprises one or more permitted suspend indicators which indicate where in the command stream a processing task is permitted to be suspended.

11. The system of claim 10, wherein the processing resource is configured to, in response to a request to resume a previously suspended processing task, retrieve from the main memory resource some or all of the data previously saved to the main memory resource when processing of the task which is to be resumed was suspended.

12. The system of claim 11, wherein the data retrieved when the processing task which is to be resumed is resumed comprises some but not all of the data which was saved to the main memory resource when the processing task which is to be resumed was suspended.

13. A method of generating a command stream for causing a processing resource operable to perform data processing operations for applications executing on a host processor to perform a processing task comprising one or more processing operations;
the method comprising including in the command stream:
a sequence of commands for execution by the processing resource to cause the processing resource to perform the processing operations for the processing task; and
one or more data save indicators indicative of data that should be saved in the event of processing of the processing task being suspended.

14. The method of claim 13, further comprising:
including a data save indicator in the command stream based on one or more of:
whether a command or commands in the command stream will generate new data or change existing data when executed;
whether the command stream includes a particular type of command;
the execution duration of commands in the command stream; and
the number of commands in the command stream since the previous data save indicator in the command stream.

15. The method of claim 13, further comprising including one or more permitted suspend indicators in the command stream, the one or more permitted suspend indicators configured to indicate where in the command stream the processing of the processing task may be suspended.

16. The method of claim 15, further comprising:
including a permitted suspend indicator in the command stream based on one or more of:
whether a command or commands in the command stream will generate new data or change existing data when executed;
whether the command stream includes a particular type of command;
the execution duration of commands in the command stream; and
the number of commands in the command stream since the previous permitted save indicator in the command stream.

17. The method of claim 13, further comprising including one or more data retrieval indicators in the command stream, the one or more data retrieval indicators configured to indicate data which should be retrieved from the main memory resource when the processing task is resumed after having been previously suspended.

18. The method of claim 17, further comprising:
including a data retrieval indicator in the command stream based on one or more of:
the location of one of the one or more data save indicators in the command stream; and
whether data that will be generated or changed on execution of a preceding command or commands in the command stream will be required in the further execution of the command stream.

19. A non-transitory computer readable storage medium storing computer software code that, when executing on at least one processor, performs a method of generating a command stream for causing a processing resource operable to perform data processing operations for applications executing on a host processor to perform a processing task comprising one or more processing operations;
the method comprising including in the command stream:
a sequence of commands for execution by the processing resource to cause the processing resource to perform the processing operations for the processing task; and
one or more data save indicators indicative of data that should be saved in the event of processing of the processing task being suspended.
